(19) United States
(12) Patent Application Publication
(10) Pub. No.: US 2013/0180630 A1
(43) Pub. Date: Jul. 18, 2013

(54) Cu-Co-Si-BASED ALLOY FOR ELECTRONIC MATERIAL AND METHOD OF MANUFACTURING THE SAME

(71) Applicants: Yasuhiro Okafuji, Ibaraki (JP); Takuma Onda, Ibaraki (JP); Hiroshi Kuwagaki, Ibaraki (JP)

(72) Inventors: Yasuhiro Okafuji, Ibaraki (JP); Takuma Onda, Ibaraki (JP); Hiroshi Kuwagaki, Ibaraki (JP)

(73) Assignee: JX NIPPON MINING & METALS CORPORATION, Tokyo (JP)

(21) Appl. No.: 13/876,185

(22) PCT Filed: Sep. 6, 2011
(86) PCT No.: PCT/JP11/70275

§ 371 Date: Mar. 27, 2013

(30) Foreign Application Priority Data
Sep. 29, 2010 (JP) 2010-219694

(51) Int. Cl. H01B 1/02

(52) U.S. Cl. CPC H01B 1/026
USPC 148/554; 148/411; 148/412; 148/413; 148/414

(57) ABSTRACT

A Cu—Co—Si-based alloy that has even mechanical properties and that is provided with favorable mechanical and electrical properties as a copper alloy for an electronic material is provided. The copper alloy for an electronic material comprises 0.5% by mass to 3.0% by mass of Co, 0.1% by mass to 1.0% by mass of Si, and the balance Cu with inevitable impurities. An average grain size is in the range of 3 μm to 15 μm and an average difference between a maximum grain size and a minimum grain size in every observation field of 0.05 mm² is 5 μm or less.

### BACKGROUND

1. Technical Field

The present invention relates to a precipitation hardening copper alloy, and particularly to, a Cu—Co—Si-based alloy suitable for use in various electronic equipment components.

2. Related Art

It is necessary to coexist high strength and a high conductive property (or thermal conductivity) as basic characteristics in copper alloys for an electronic material which are used for various types of electronic equipment components such as connectors, switches, relays, pins, terminals, and lead frames. In recent years, high integration and a reduction in size and thickness of electronic components have been advanced rapidly, and in response to this, the level of demand for copper alloys which are used for electronic equipment components is increasingly advanced.

From the viewpoint of the high strength and high conductive property, usage of a precipitation hardening copper alloy increases instead of a solid-solution strengthening copper alloy represented by conventional phosphor bronze and brass as a copper alloy for an electronic material. In the precipitation hardening copper alloy, fine precipitates are uniformly dispersed by aging a supersaturated solid solution subjected to a solution treatment, and thus the amount of elements formed into the solid solution in copper decreases simultaneously with an increase in strength of the alloy, and the electric conducting property is improved. Therefore, it is possible to obtain a material having excellent mechanical properties such as strength and a spring property, a favorable electric conducting property, and favorable thermal conductivity.

From among precipitation hardening copper alloys, a Cu—Ni—Si-based alloy which is generally referred to as a Corson alloy is a representative copper alloy having a relatively high conductive property, strength, and bending workability, and is one of alloys which are being actively developed in the field. In this copper alloy, fine Ni—Si-based intermetallic compound particles are precipitated in a copper matrix to improve the strength and the conductivity.

There is an attempt to further improve the characteristics by adding Co to the Corson alloy.

JP 11-222641 A discloses that Co is similar to Ni in forming a compound with Si and improving mechanical strength, and when a Cu—Co—Si-based alloy is aged, it has better mechanical strength and a better conductive property than a Cu—Ni—Si-based alloy and the Cu—Co—Si-based alloy may be selected if the cost is acceptable. It is also disclosed that when Co is added, the optimum amount of Co is 0.05 wt % to 2.0 wt %.

JP 2005-532477 W discloses that the content of cobalt is set in the range of 0.5% by mass to 2.5% by mass. The reason for this is that, when the cobalt content is less than 0.5%, the precipitation of cobalt-containing silicide as a second phase is insufficient, and when the cobalt content is greater than 2.5%, second phase particles excessively precipitate, whereby workability is reduced and the copper alloy is endowed with undesirable ferromagnetic characteristics. The cobalt content is preferably in the range of about 0.5% to about 1.5%, and is in the range of about 0.7% to about 1.2% in the most preferable embodiment.

The copper alloy disclosed in JP 2008-248333 A has been developed for the purpose of using it mainly for terminals for automobile use, communicators, and the like, or as connector materials. The copper alloy is a Cu—Co—Si-based alloy in which the Co concentration is in the range of 0.5 wt % to 2.5 wt % and a high conductive property and moderate strength are achieved. According to JP 2008-248333 A, the reason for determining the Co concentration in the above range is that, when the amount of Co added is less than 0.5% by mass, desired strength cannot be obtained, and when the amount of Co added is greater than 2.5% by mass, high strength is obtained, but the conductivity is significantly reduced and also hot workability deteriorates. Co is preferably in the range of 0.5% by mass to 2.0% by mass.

The copper alloy disclosed in JP 9-20943 A has been developed for the purpose of achieving high strength, a high conductive property, and high bending workability, and the Co concentration is determined in the range of 0.1 wt % to 3.0 wt %. The reason for restricting the Co concentration as described above is disclosed; that is, it is not preferable that the Co concentration be less than the composition range because the above-described effects are not obtained, and it is also not preferable that cobalt be added at a concentration greater than the composition range because a crystallized phase is generated in casting and it leads to casting cracks.

JP 2009-242814 A and JP 2008-266787 A disclose a method in which second phase particles are dispersed by performing an aging precipitation heat treatment for 5 seconds to 20 hours at 400° C. to 800° C. after facing to inhibit the growth in the solution treatment, thereby controlling a grain size to 10 μM or less. In this method, second phase particles which inhibit the growth of precipitates can be dispersed in the Ni—Si-based copper alloy and the like, but the size of the second phase particles are unlikely to increase in the Co—Si-based copper alloy, and the particles are required to be subjected to the solution treatment at high temperature, whereby it is difficult to suppress an increase in grain size.

JP 2010-59543 A discloses that a rate of temperature increase in the solution treatment is controlled to disperse second phase particles to thereby inhibit an increase in grain size, thereby suppressing the grain size to 3 μm to 20 μm and suppressing the standard deviation to 8 μm or less. However, this invention is adapted to measure the standard deviation of the grain size in a sample and to improve bendability, and a variation in characteristics is not suppressed. In addition, the standard deviation of 8 μm corresponds to a significant variation, and when a variation in particle size is ±36 or less, a difference of ±24 μm is caused and the variation in characteristics cannot be suppressed. Furthermore, it is difficult to control the rate of temperature increase in the solution treatment and the variation in grain size cannot be suppressed. In addition, a variation between production lots is also anticipated to increase.

JP 2009-242932 A discloses that a Cu—Ni—Co—Si-based alloy is aged at 350° C. to 500° C. before the solution treatment so that an average grain size is in the range of 15 μm to 30 μm and an average difference between the maximum grain size and the minimum grain size in every 0.5 mm² is 10 μm or less. However, bending roughness is 1.5 μm and it is thought that characteristics are insufficient as a future copper alloy for an electronic component. In addition, since the alloy type is different, the precipitation rate in the aging treatment is different and it is necessary to closely examine the grain size control method.
Patent document 1: JP 11-222641 A
Patent document 2: JP 2005-532477 W
Patent document 3: JP 2008-248333 A
Patent document 4: JP 9-20943 A
Patent document 5: JP 2009-242814 A
Patent document 6: JP 2008-266787 A
Patent document 7: JP 2010-59543 A
Patent document 8: JP 2009-242932 A

It is known that adding Co contributes to an improvement in characteristics of the copper alloy, but as disclosed in the above-described related art, in the process of manufacturing the Cu—Co—Si-based alloy, it is necessary to perform the solution treatment at high temperature, and in that case, recrystallized grains are easily coarsened. In addition, second phase particles such as crystallites and precipitates formed before the solution treatment process act as obstacles and inhibit the growth of grains. Therefore, ununiformity of recrystallized grains in the alloy increases and a problem occurs in that a variation in mechanical characteristics of the alloy becomes large.

### SUMMARY

An object of the invention is to provide a high concentration Co-containing Cu—Co—Si-based alloy which has uniform mechanical characteristics with a high conductive property, high strength, and high bending workability, and another object of the invention is to provide a method for manufacturing the Cu—Co—Si-based alloy.

The inventors have conducted intensive study on means for reducing a variation in recrystallized grains and as a result, found that in manufacturing of a Cu—Co—Si-based alloy, performing an aging treatment before a solution treatment is suitable as a method of uniformly precipitating fine second phase particles spaced as equally as possible in a copper matrix before the solution treatment process. They have found that since cold rolling is generally performed before the solution treatment and the aging treatment is performed in a state in which strains are added, second phase particles easily grow, and even when the solution treatment is performed at a relatively high temperature, the size of grains does not increase so much due to the pinning effect of the second phase particles. Moreover, they have also found that since the pinning effect uniformly work on the whole copper matrix, the size of the growing recrystallized grains can also be uniformized. In addition, the strains are removed by the aging treatment before the solution treatment and the rate of increase of the grain size in the solution treatment can be reduced. They have found that as a result, a Cu—Co—Si-based alloy having excellent bendability with a small variation in mechanical characteristics is obtained.

According to an aspect of the invention made based on the above-described findings, there is provided a copper alloy for an electronic material containing 0.5% by mass to 3.0% by mass of Co, 0.1% by mass to 1.0% by mass of Si, and the balance Cu with inevitable impurities, in which an average grain size is in the range of 3 μm to 15 μm and an average difference between a maximum grain size and a minimum grain size in every observation field of 0.05 mm² is 5 μm or less.

In one embodiment, the copper alloy according to the invention further contains Cr in an amount of up to 0.5% by mass.

In another embodiment, the copper alloy according to the invention further contains one or two or more selected from Mg, Mn, Ag, and P in total in an amount of up to 0.5% by mass.

In another embodiment, the copper alloy according to the invention further contains one or two selected from Sn and Zn in total in an amount of up to 2.0% by mass.

In another embodiment, the copper alloy according to the invention further contains one or two or more selected from Ni, As, Sb, Be, B, Ti, Zr, Al, and Fe in total in an amount of up to 2.0% by mass.

According to another aspect of the invention, there is provided a method of manufacturing a copper alloy, including: a step 1 in which an ingot having a desired composition is melted and cast; a step 2 in which the ingot is heated for 1 hour or longer at 950° C. to 1050° C., hot-rolled, and then cooled at an average cooling rate of 15° C./s or greater from 850° C. or higher as a temperature at the end of the hot rolling to 400° C.; a cold rolling step 3 at a processing ratio of 70% or greater; an aging treatment step 4 in which the cold-rolled material is heated for 1 minute to 24 hours at 510° C. to 800° C.; a step 5 in which the aged material is subjected to a solution treatment at 850° C. to 1050° C. and cooled at an average cooling rate of 15° C./s or greater when the material temperature is reduced from 850° C. to 400° C.; an optional cold rolling step 6; an aging treatment step 7; and an optional cold rolling step 8, in which the steps are sequentially performed.

According to a further aspect of the invention, there is provided a wrought copper product including the copper alloy.

According to a still further aspect of the invention, there is provided an electronic equipment component including the copper alloy.

According to the invention, a Cu—Co—Si-based alloy with uniform mechanical characteristics which has suitable mechanical and electrical characteristics as a copper alloy for an electronic material is obtained.

### BRIEF DESCRIPTION OF DRAWINGS

FIG. 1 is a diagram illustrating a stress relaxation test; and

FIG. 2 is a diagram illustrating the amount of permanent set in the stress relaxation test.

### DETAILED DESCRIPTION

### Amounts of Co and Si Added

Co and Si form an intermetallic compound through an appropriate heat treatment and make it possible to increase strength without deterioration in conductivity.

When the amount of Co added is less than 0.5% by mass and the amount of Si added is less than 0.1% by mass, desired strength may not be obtained, and conversely, when the amount of Co added is greater than 3.0% by mass and the amount of Si added is greater than 1.0% by mass, high strength is achieved, but the conductivity is significantly reduced and also hot workability deteriorates. Therefore, the amount of Co added is in the range of 0.5% by mass to 3.0% by mass and the amount of Si added is in the range of 0.1% by mass to 1.0% by mass. Higher strength is more desired for Cu—Co—Si-based alloys than Cu—Ni—Si-based alloys and Cu—Ni—Si—Co-based alloys. Therefore, it is desirable that Co be present at a high concentration, and the concentration is preferably 1.0% or greater, and more preferably 1.5% or greater. That is, the amount of Co added is preferably in the range of 1.0% by mass to 2.5% by mass, and more preferably 1.5% by mass to 2.0% by mass, and the amount of Si added is preferably in the range of 0.3% by mass to 0.8% by mass, and more preferably 0.4% by mass to 0.6% by mass.

### Amount of Cr Added

Since Cr preferentially precipitates at grain boundaries in a cooling process during melting and casting, the grain boundaries may be strengthened, cracks are not easily caused in hot processing, and a reduction in yield may be suppressed. That is, Cr that has precipitated at the grain boundaries during melting and casting is formed into a solid solution again through a solution treatment or the like, resulting in generating precipitated particles or compounds with Si having a bcc structure including Cr as a main component in the subsequent aging precipitation. In general Cu—Ni—Si-based alloys, a part of added Si, which has not contributed to the aging precipitation, suppresses an increase in conductivity while being formed into a solid solution in the matrix. However, the amount of Si formed into a solid solution may be reduced and the conductivity may be increased without impairing strength by adding Cr as a silicide-forming element and causing silicide to further precipitate. However, when the Cr concentration is greater than 0.5% by mass, coarse second phase particles are easily formed and product characteristics are thus impaired. Therefore, in a Cu—Co—Si-based alloy according to the invention, Cr may be added in an amount of up to 0.5% by mass. However, since the effect of the addition is small when the amount is less than 0.03% by mass, the added amount may be preferably 0.03% by mass to 0.5% by mass, and more preferably 0.09% by mass to 0.3% by mass.

### Amounts of Mg, Mn, Ag, and P Added

Mg, Mn, Ag and P added in small amounts improve product characteristics such as strength and a stress relaxation characteristic without impairing the conductivity. The effect of the addition is mainly exhibited through forming into a solid solution in the matrix, but the effect may be further exhibited when the elements are contained in second phase particles. However, when the total concentration of Mg, Mn, Ag and P is greater than 0.5%, the characteristic improvement effect becomes saturated and manufacturability is impaired. Therefore, in the Cu—Co—Si-based alloy according to the invention, one or two or more selected from Mg, Mn, Ag and P may be added in total in an amount of up to 0.5% by mass. However, since the effect of the addition is small when the amount is less than 0.01% by mass, the total added amount may be preferably in the range of 0.01% by mass to 0.5% by mass, and more preferably 0.04% by mass to 0.2% by mass.

### Amounts of Sn and Zn Added

Sn and Zn added in small amounts also improve product characteristics such as strength, a stress relaxation characteristic, and a plating property without impairing the conductivity. The effect of the addition is mainly exhibited through forming into a solid solution in the matrix. However, when the total amount of Sn and Zn is greater than 2.0% by mass, the characteristic improvement effect becomes saturated and manufacturability is impaired. Therefore, in the Cu—Co—Si-based alloy according to the invention, one or two selected from Sn and Zn may be added in total in an amount of up to 2.0% by mass. However, since the effect of the addition is small when the amount is less than 0.05% by mass, the total added amount may be preferably in the range of 0.05% by mass to 2.0% by mass, and more preferably 0.5% by mass to 1.0% by mass.

### Ni, As, Sb, Be, B, Ti, Zr, Al, and Fe

Product characteristics such as conductivity, strength, a stress relaxation characteristic, and a plating property are improved by adjusting the amounts of Ni, As, Sb, Be, B, Ti, Zr, Al, and Fe added in accordance with the demanded product characteristics. The effect of the addition is mainly exhibited through forming into a solid solution in the matrix, but the effect may be further exhibited when the elements are contained in second phase particles or when second phase particles having a new composition are formed. However, when the total amount of the elements is greater than 2.0% by mass, the characteristic improvement effect becomes saturated and manufacturability is impaired. Therefore, in the Cu—Co—Si-based alloy according to the invention, one or two or more selected from Ni, As, Sb, Be, B, Ti, Zr, Al and Fe may be added in total in an amount of up to 2.0% by mass. However, since the effect of the addition is small when the amount is less than 0.001% by mass, the total added amount may be preferably in the range of 0.001% by mass to 2.0% by mass, and more preferably 0.05% by mass to 1.0% by mass.

Since manufacturability is easily impaired when the total amount of the above-described Mg, Mn, Ag, P, Sn, Zn, Ni, As, Sb, Be, B, Ti, Zr, Al, and Fe added is greater than 3.0% by mass, the total added amount is preferably 2.0% by mass or less, and more preferably 1.5% by mass or less.

### Grain Size

Generally, hall-Petch rule in which grains have an influence on strength and the strength is proportional to (grain size)^{-1/2} is established. In addition, coarse grains deteriorate bending workability and become a cause for rough surface in bending work. Generally, therefore, it is desirable that grains be subjected to refinement in order to improve strength in the copper alloy. Specifically, the grain size is preferably 15 μm or less, and more preferably 10 μm or less.

Meanwhile, since the Cu—Co—Si-based alloy according to the invention is a precipitation strengthening alloy, it is also necessary to note the precipitation state of second phase particles. The second phase particles precipitated in grains in the aging treatment contribute to an improvement in strength, but the second phase particles precipitated at grain boundaries contribute little to an improvement in strength. Therefore, in order to improve strength, it is desirable that the second phase particles be precipitated in grains. When the grain size decreases, the grain boundary area increases. Accordingly, the second phase particles are easily precipitated preferentially at grain boundaries in the aging treatment. In order to precipitate the second phase particles in grains, it is necessary that the grains have a certain level of size. Specifically, the grain size is preferably 3 μm or greater, and more preferably 5 μm or greater.

In the invention, the average grain size is controlled in the range of 3 to 15 μm. The average grain size is preferably in the range of 5 μm to 10 μm. Both the strength improvement effect due to the refinement of grains and the strength improvement effect due to the precipitation hardening may be achieved in a balanced manner by controlling the average grain size in such a range. In addition, when the grain size is in the above range, excellent bending workability and an excellent stress relaxation characteristic may be obtained.

In the invention, the grain size indicates the diameter of a minimum circle surrounding each of grains when a cross-section surface in the thickness direction parallel to the rolling direction is observed using a microscope. The average grain size indicates an average value of the grain sizes.

In the invention, an average difference between the maximum grain size and the minimum grain size in every observation field of 0.05 mm² is 5 μm or less, and preferably 3 μm or less. Although the average difference is ideally 0 μm, it is realistically difficult to be achieved. Therefore, the lower limit thereof is 1 μm from the actual minimum value, and typically, the optimum lower limit is in the range of 1 μm to 3 μm. Here, the maximum grain size indicates a maximum grain size observed in an observation field of 0.05 mm², and the minimum grain size indicates a minimum grain size observed in the same field. In the invention, differences between the maximum grain size and the minimum grain size are respectively measured in a plurality of observation fields, and an average value thereof is set as the average difference between the maximum grain size and the minimum grain size.

A small difference between the maximum grain size and the minimum grain size means that the grain size is uniform, and a variation in mechanical characteristics at every measurement point in the same material is reduced. As a result, quality stability of wrought copper products and electronic equipment components obtained by processing the copper alloy according to the invention is improved.

### Manufacturing Method

In a general process of manufacturing a Corson copper alloy, first, raw materials such as electrolytic copper, Si, and Co are melted using an atmosphere melting furnace, thereby obtaining a molten metal having a desired composition. The molten metal is cast into an ingot. Thereafter, hot rolling is performed, cold rolling and a heat treatment are repeated, and thus the ingot is shaped into a strip or foil having a desired thickness and desired characteristics. The heat treatment includes a solution treatment and an aging treatment. In the solution treatment, heating is performed at a high temperature of about 700° C. to about 1000° C. to form second phase particles into a solid solution in a matrix and recrystallize. Hot rolling may include the solution treatment. In the aging treatment, heating is performed for 1 hour or longer in a temperature range of about 350° C. to about 600° C., and the second phase particles formed into the solid solution through the solution treatment are precipitated as nanometer-order fine particles. The aging treatment results in increased strength and conductivity. Cold rolling may be performed before and/or after the aging in order to obtain higher strength. In addition, stress relief annealing (low-temperature annealing) may be performed after the cold rolling when cold rolling is performed after the aging.

Grinding, polishing, shot blast pickling and the like are suitably performed in order to suitably remove oxidized scale on the surface between the above-described processes.

Basically, the above-described manufacturing process is also used for the copper alloy according to the invention. However, as described above, it is important to uniformly precipitate fine second phase particles spaced as equally as possible in a copper matrix before the solution treatment process in order to control the average grain size and the variation in grain size in the ranges as determined in the invention. In order to obtain the copper alloy according to the invention, it is necessary to manufacture the copper alloy with particular attention to the following points.

First, since coarse crystallites are unavoidably generated in the course of solidification during casting and coarse precipitates are unavoidably generated in the course of cooling, it is necessary to form the crystallites into a solid solution in a matrix in the subsequent process. After holding for 1 hour or longer at 950° C. to 1050° C., hot rolling is performed, and when the temperature at the end of the hot rolling is 850° C. or higher, a solid solution may be formed in the matrix even when Co, and Cr as well, are added. The temperature condition of 950° C. or higher is a higher temperature setting than in the case of other Corson alloys. When the holding temperature before hot rolling is lower than 950° C., forming into a solid solution may not be sufficient, and when the holding temperature before hot rolling is higher than 1050° C., the material may melt. In addition, when the temperature at the end of the hot rolling is lower than 850° C., the elements which have been formed into a solid solution precipitate again, and thus it is difficult to obtain high strength. Therefore, in order to obtain high strength, it is desirable that hot rolling be ended at 850° C. and the material be rapidly cooled.

At this time, when the cooling rate is low, Si-based compounds containing Co and Cr precipitate again. When a heat treatment (aging treatment) is performed for the purpose of improving strength with such a constitution, precipitates formed in the cooling process become cores and grow as coarse precipitates which do not contribute to strength, whereby high strength may not be obtained. Therefore, it is necessary that the cooling rate should be as high as possible, specifically, 15° C./s or greater. However, since the second phase particles remarkably precipitate at up to about 400° C., the cooling rate at a temperature of lower than 400° C. does not make any problems. Therefore, in the invention, the cooling is performed at an average cooling rate of 15° C./s or greater, and preferably 20° C./s or greater when the material temperature is reduced from 850° C. to 400° C. “The average cooling rate when the temperature is reduced from 850° C. to 400° C.” indicates a value (° C./s) being calculated by a formula of “(850-400)(° C.)/cooling time (s)”, where the cooling time is measured as a time during which the material temperature is reduced from 850° C. to 400° C.

Cold rolling is conducted after the hot rolling. The cold rolling is conducted for the purpose of increasing strains which will be precipitation sites in order to form precipitates uniformly. The cold rolling is preferably conducted at a reduction rate of 70% or greater, and more preferably 85% or greater. When the cold rolling is not conducted and the solution treatment is conducted just after the hot rolling, precipitates are not uniformly formed. A combination of the hot rolling and the subsequent cold rolling may be repeated appropriately.

A first aging treatment is conducted after the cold rolling. When the second phase particles remain before conducting this process, such second phase particles further grow when this process is conducted, and thus there is a difference in particle size between the above second phase particles and second phase particles which are formed in this process. However, in the invention, since most of the second phase particles are eliminated in the former process, fine second phase particles having a uniform size may be formed uniformly.

When the aging temperature of the first aging treatment is too low, however, the precipitation amount of second phase particles providing a pinning effect decreases and the pinning effect which is generated in the solution treatment are only partially obtained. Accordingly, the size of the grains varies. On the other hand, when the aging temperature is too high, the second phase particles become coarse and also are ununiformly formed, and thus the size of the second phase particles varies. In addition, the longer the aging time, the larger the second phase particles grow, and thus it is necessary to set the aging time appropriately.

The first aging treatment is performed at 510° C. to 800° C. for 1 minute to 24 hours, and preferably at greater than 510° C. to lower than 600° C. for 12 hours to 24 hours, at greater than 600° C. to lower than 700° C. for 1 hour to 15 hours, and at greater than 700° C. to lower than 800° C. for 1 minute to 1 hour. Thus, fine second phase particles may be uniformly formed in the matrix. With such a constitution, the growth of recrystallized grains which are generated in the solution treatment which is the next process may be uniformly pinned, and a particle-size-regulated constitution with a small variation in grain size may be obtained.

The solution treatment is performed after the first aging treatment. Here, fine and uniform recrystallized grains are grown while forming a solid solution of the second phase particles. Therefore, it is necessary to set the solution treatment temperature to 850° C. to 1050° C. Here, the recrystallized grains are grown first, and then the second phase particles precipitated in the first aging treatment are formed into a solid solution. Accordingly, the growth of the recrystallized grains can be controlled by the pinning effect. However, the pinning effect wears off after the second phase particles are formed into the solid solution, and thus the recrystallized grains become large when the solution treatment is continued for a long time. Therefore, an appropriate solution treatment time is 30 seconds to 300 seconds, and preferably 60 seconds to 180 seconds at greater than 850° C. to lower than 950° C., and 30 seconds to 180 seconds, and preferably 60 seconds to 120 seconds at greater than 950° C. to lower than 1050° C.

Also in the cooling process after the solution treatment, the average cooling rate when the material temperature is reduced from 850° C. to 400° C. is set to 15° C./s or greater, and preferably 20° C./s or greater in order to avoid the precipitation of the second phase particles.

A second aging treatment is conducted after the solution treatment. Conditions for the second aging treatment may be the conditions that are generally used because of their availability for refinement of the precipitates. However, it is necessary to note that the temperature and time should be set so that the precipitates may not be coarsened. As the conditions for the aging treatment, for example, the temperature is in the range of 400° C. to 600° C. and the time is in the range of 1 hour to 24 hours, and preferably, the temperature is in the range of 450° C. to 550° C. and the time is in the range of 5 hours to 24 hours. In addition, the cooling rate after the aging treatment has little influence on size of the precipitates. Before the second aging treatment, precipitation sites are increased and age hardening is promoted using the precipitation sites to increase strength. After the second aging treatment, work hardening is promoted using the precipitates to improve strength. Cold rolling may also be conducted before and/or after the second aging treatment.

The Cu—Co—Si-based alloy of the invention may be processed to produce various wrought copper products such as plates, strips, tubes, rods, and wires. Furthermore, the Cu—Co—Si-based copper alloy according to the invention may be used in electronic components such as lead frames, connectors, pins, terminals, relays, switches, and foil materials for secondary batteries.

### Examples

Hereinafter, examples of the invention will be described with comparative examples. The examples are provided in order to understand the invention and advantages thereof better, but the invention is not limited thereto.

Copper alloys having a component composition listed in Tables 1 and 2 (Examples) and Table 3 (Comparative Examples) were melted at 1300° C. using a high-frequency melting furnace and casted into ingots having a thickness of 30 mm. Next, the ingots were heated for 2 hours at 1000° C., and then hot-rolled to have a sheet thickness of 10 mm and the finishing temperature (temperature at which the hot rolling was ended) was 900° C. After completing the hot rolling, the resultant materials were water-cooled at an average cooling rate of 18° C./s when the material temperature was reduced from 850° C. to 400° C., and then cooled by being left in the air. Next, the materials were faced to have a thickness of 9 mm in order to remove scale from the surfaces thereof, and then cold-rolled to obtain sheets having a thickness of 0.15 mm. Next, a first aging treatment was performed thereon at various aging temperatures for 1 minute to 15 hours (this aging treatment was not performed in some of Comparative Examples), and then the sheets were subjected to a solution treatment by raising the temperature to various solution treatment temperatures at a rate of temperature increase of 10° C./s to 15° C./s (the rate of temperature increase was 50° C./s in some of Comparative Examples) and holding for 120 seconds at the solution treatment temperatures. Thereafter, the sheets were immediately water-cooled at an average cooling rate of 18° C./s when the material temperature was reduced from 850° C. to 400° C., and then cooled by being left in the air. Next, these were cold-rolled to have a thickness of 0.10 mm, subjected to a second aging treatment in an inert atmosphere at 550° C. for 3 hours, and finally cold-rolled to have a thickness of 0.25 mm, thereby manufacturing test pieces.

The following various characteristic evaluations were performed on the test pieces obtained as described above.

(1) Average Grain Size

Resin embedding was performed for arbitrarily collected 15 samples in such a manner that their observation surfaces were cross-section surfaces in the thickness direction parallel to the rolling direction, and the observation surfaces were subjected to mirror finish by mechanical polishing. Then, in a solution prepared by blending at a ratio of 10 parts by volume of hydrochloric acid of a concentration of 36% to 100 parts by volume of water, ferric chloride having a weight of 5% of the weight of the solution was dissolved. In the solution prepared in this manner, the samples were immersed for 10 seconds, whereby metal constituents appeared. Next, the metal constituents were magnified 1000 times by a scanning electron microscope, photographs including their observation fields of 0.05 mm² were taken, the diameter of a minimum circle surrounding each of grains was obtained, and then an average value thereof was calculated in every observation field. The average value of the 15 observation fields was set as an average grain size.

(2) Average Difference Between Maximum Grain Size and Minimum Grain Size

With respect to the grain sizes measured when obtaining the average grain size, a difference between the maximum value and the minimum value was obtained in every field. The average value of the 15 observation fields was set as an average difference between the maximum grain size and the minimum grain size.

(3) Strength

With respect to strength, a tensile test was performed in a direction parallel to the rolling direction, and 0.2% yield strength (YS: MPa) was measured. The variation in strength according to the measurement point corresponds to differences between the maximum strength and the minimum strength of 30 points and the average strength is an average value of the 30 points.

(4) Conductivity

The conductivity (EC; % IACS) was obtained by measuring volume resistivity using a double bridge. The variation in conductivity according to the measurement point corresponds to differences between the maximum conductivity and the minimum conductivity of 30 points and the average conductivity is an average value of the 30 points.

(5) Stress Relaxation Characteristic

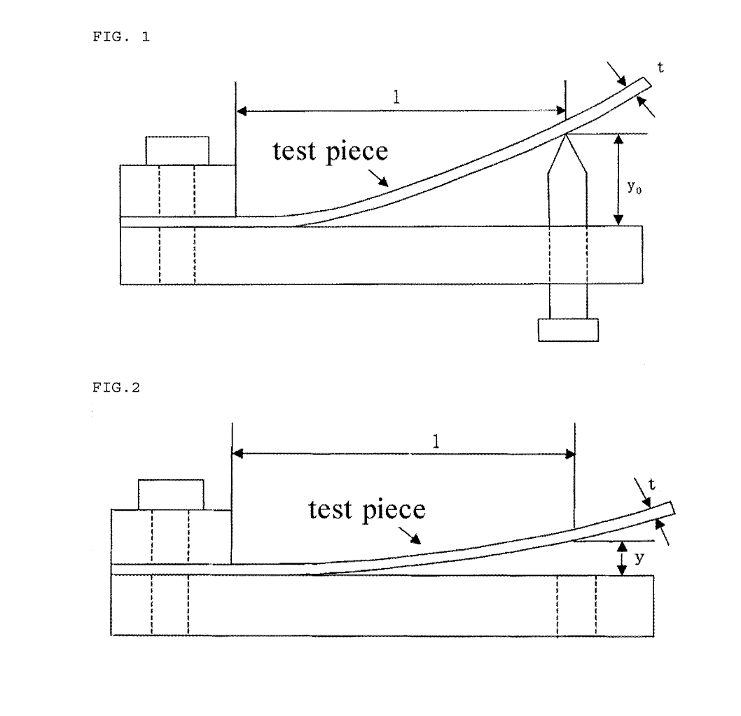

In measuring the stress relaxation characteristic, as in FIG. 1, bending stress was loaded to each test piece having a thickness t of 0.25 mm, which had been worked to have a width of 10 mm and a length of 100 mm, under the condition that a gage length 1 was 25 mm and a height y₀ was determined so that the load stress was 80% of 0.2% yield strength. After heating at 150° C. for 1000 hours, an amount of permanent set (height) y as illustrated in FIG. 2 was measured and stress relaxation percentage {[1−(y−y₁)(mm)/(y₀−y₁)(mm)]×100(%)} was calculated. y₁ indicates a height of initial camber before loading the stress. The variation in stress relaxation percentage according to the measurement point corresponds to differences between the maximum stress relaxation percentage and the minimum stress relaxation percentage of 30 points and the average stress relaxation percentage is an average value of the 30 points.

(6) Bending Workability

Bending workability was evaluated by a roughness surface of a bending part. A W-bending test in Bad Way (the bending axis was in a direction parallel to the rolling direction) was performed in accordance with JIS H 3130 to analysis the surface of the bending part using a confocal laser scanning microscope and obtain Ra (μm) regulated in JIS B 0601. The variation in bending roughness according to the measurement point corresponds to differences between the maximum Ra and the minimum Ra of 30 points and the average bending roughness is an average value of Ra of the 30 points.

TABLE 1

| | | | | | | | | Maxi- | | | Aver- | | | | |
|---|---|---|---|---|---|---|---|---|---|---|---|---|---|---|---|
| | | | | | | | | mum | | | age | | | | Varia- |
| | | | | | | Solu- | | Grain | | | Stress | Aver- | | Varia- | tion |
| | | | | | | tion | | Size- | | Aver- | Relax- | age | | tion | in |
| | | | | | Aging | Treat- | Aver- | Min- | | age | ation | Bend- | Varia- | in | Bend- |
| | | | | | Tem- | ment | age | imum | | Conduc- | Per- | ing | tion | Stress | ing |
| | Composition | | | | per- | Temper- | Grain | Grain | Average | tivity | cent- | Rough- | in | Relax- | Rough- |
| Example | (% by mass) | | | | ature | ature | Size | Size | Strength | (% | age | ness | Strength | ation | ness |
| No. | Co | Si | Cr | Others | (° C.) | (° C.) | (μm) | (μm) | (MPa) | IACS) | (%) | (μm) | (MPa) | (%) | (μm) |
| 1 | 0.7 | 0.17 | | | 650 | 850 | 5 | 2 | 601 | 70 | 81 | 0.79 | 23 | 2.1 | 0.35 |
| 2 | 0.7 | 0.17 | 0.2 | | 650 | 850 | 4 | 1 | 605 | 71 | 80 | 0.68 | 22 | 2.0 | 0.29 |
| 3 | 1.2 | 0.28 | | | 600 | 900 | 9 | 3 | 635 | 64 | 81 | 1.25 | 24 | 2.3 | 0.43 |
| 4 | 1.2 | 0.28 | 0.2 | | 600 | 900 | 7 | 4 | 633 | 65 | 82 | 1.16 | 22 | 2.2 | 0.51 |
| 5 | 1.2 | 0.28 | | 0.1 Mg | 600 | 900 | 8 | 4 | 664 | 60 | 88 | 1.18 | 23 | 2.2 | 0.49 |
| 6 | 1.2 | 0.28 | 0.2 | 0.1 Mg | 600 | 900 | 6 | 2 | 662 | 62 | 89 | 1.01 | 20 | 2.0 | 0.39 |
| 7 | 1.2 | 0.25 | | | 600 | 900 | 10 | 4 | 615 | 62 | 81 | 1.31 | 23 | 2.5 | 0.44 |
| 8 | 1.2 | 0.31 | | | 600 | 900 | 9 | 3 | 636 | 62 | 81 | 1.33 | 24 | 2.4 | 0.43 |
| 9 | 1.2 | 0.39 | | | 600 | 900 | 8 | 3 | 640 | 59 | 80 | 1.27 | 22 | 2.3 | 0.40 |
| 10 | 2.0 | 0.48 | | | 550 | 950 | 8 | 3 | 723 | 61 | 82 | 1.41 | 25 | 2.2 | 0.52 |
| 11 | 2.0 | 0.48 | 0.2 | | 550 | 950 | 7 | 2 | 726 | 63 | 82 | 1.42 | 26 | 2.3 | 0.52 |
| 12 | 2.0 | 0.48 | | | 550 | 1000 | 14 | 5 | 752 | 59 | 83 | 1.84 | 29 | 2.1 | 0.61 |
| 13 | 2.0 | 0.48 | 0.2 | | 550 | 1000 | 13 | 5 | 751 | 61 | 83 | 1.85 | 29 | 2.1 | 0.63 |
| 14 | 2.5 | 0.60 | | | 510 | 1000 | 14 | 5 | 763 | 59 | 84 | 1.87 | 30 | 2.0 | 0.65 |
| 15 | 2.5 | 0.60 | 0.2 | | 510 | 1000 | 13 | 5 | 765 | 61 | 84 | 1.86 | 31 | 2.0 | 0.65 |
| 16 | 3.0 | 0.71 | | | 800 | 1000 | 13 | 4 | 777 | 57 | 85 | 1.94 | 30 | 2.3 | 0.67 |
| 17 | 3.0 | 0.71 | 0.5 | | 510 | 1000 | 12 | 4 | 781 | 59 | 86 | 1.85 | 31 | 2.1 | 0.68 |

TABLE 2

| | | | | | | | | | | | | Aver- | | | | |
|---|---|---|---|---|---|---|---|---|---|---|---|---|---|---|---|---|
| | | | | | | | | | | | Aver- | age | | | | |
| | | | | | | | | | Maxi- | | age | Stress | | | | |
| | | | | | | | Solution | | mum | | Con- | Relax- | Aver- | | | Varia- |
| | | | | | | Aging | Treat- | Aver- | Grain | | duc- | ation | age | Varia- | Varia- | tion |
| Ex- | | | | | | Tem- | ment | age | Size- | | tiv- | Per- | Bending | tion | tion | in |
| am- | Composition | | | | | per- | Temper- | Grain | Minimum | Average | ity | cent- | Rough- | in | in Stress | Bending |
| ple | (% by mass) | | | | | ature | ature | Size | Grain Size | Strength | (% | age | ness | Strength | Relaxation | Roughness |
| No. | Co | Si | Cr | Others | | (° C.) | (° C.) | (μm) | (μm) | (MPa) | IACS) | (%) | (μm) | (MPa) | (%) | (μm) |
| 18 | 1.2 | 0.28 | | 1.3 | Ni | 600 | 900 | 8 | 3 | 805 | 55 | 90 | 1.88 | 31 | 1.9 | 0.66 |
| | | | | 0.1 | Mn | | | | | | | | | | | |
| | | | | 0.5 | Ag | | | | | | | | | | | |
| 19 | 1.2 | 0.28 | | 0.1 | P | 600 | 900 | 9 | 3 | 753 | 55 | 90 | 1.74 | 29 | 2.0 | 0.61 |
| | | | | 0.8 | Sn | | | | | | | | | | | |
| | | | | 0.5 | Zn | | | | | | | | | | | |
| 20 | 1.2 | 0.28 | | 0.1 | As | 600 | 900 | 7 | 2 | 672 | 58 | 82 | 1.22 | 27 | 2.3 | 0.39 |
| | | | | 0.1 | Sb | | | | | | | | | | | |
| | | | | 0.1 | Be | | | | | | | | | | | |
| 21 | 1.2 | 0.28 | | 0.1 | B | 600 | 900 | 8 | 3 | 641 | 65 | 83 | 1.41 | 25 | 2.2 | 0.55 |
| | | | | 0.1 | Ti | | | | | | | | | | | |
| | | | | 0.1 | Zr | | | | | | | | | | | |
| 22 | 1.2 | 0.28 | | 0.1 | Al | 600 | 900 | 7 | 2 | 629 | 59 | 88 | 1.25 | 23 | 2.4 | 0.41 |
| | | | | 0.5 | Fe | | | | | | | | | | | |
| | | | | 0.1 | Mg | | | | | | | | | | | |

TABLE 3

| | | | | | | | | Maxi- | | | | | | | |
|---|---|---|---|---|---|---|---|---|---|---|---|---|---|---|---|
| | | | | | | Solu- | | mum | | | Aver- | | | | |
| | | | | | | tion | | Grain | | Aver- | age | Aver- | | Varia- | Varia- |
| Com- | | | | | | Treat- | | Size- | | age | Stress | age | | tion | tion |
| par- | | | | | Aging | ment | Aver- | Mini- | | Con- | Relax- | Bend- | Varia- | in | in |
| ative | | | | | Tem- | Tem- | age | mum | | duc- | ation | ing | tion | Stress | Bending |
| Exam- | Composition | | | | per- | per- | Grain | Grain | Average | tivity | Percent- | Rough- | in | Relax- | Rough- |
| ple | % by mass) | | | | ature | ature | Size | Size | Strength | (% | age | ness | Strength | ation | ness |
| No. | Co | Si | Cr | Others | (° C.) | (° C.) | (μm) | (μm) | (MPa) | IACS) | (%) | (μm) | (MPa) | (%) | (μm) |
| 23 | 0.7 | 0.17 | | | — | 850 | 11 | 10 | 600 | 70 | 81 | 1.85 | 41 | 4.1 | 1.11 |
| 24 | 1.2 | 0.28 | | | — | 900 | 18 | 12 | 634 | 65 | 82 | 2.27 | 47 | 4.4 | 1.14 |
| 25 | 1.2 | 0.28 | 0.2 | | — | 900 | 17 | 12 | 635 | 66 | 82 | 2.26 | 48 | 4.5 | 1.24 |
| 26 | 2.0 | 0.48 | | | — | 950 | 23 | 14 | 721 | 60 | 83 | 2.59 | 49 | 5.1 | 1.36 |
| 27 | 2.0 | 0.48 | 0.2 | | — | 1000 | 27 | 16 | 748 | 58 | 81 | 3.12 | 51 | 4.6 | 1.51 |
| 28 | 1.2 | 0.28 | | | 600* | 900 | 16 | 10 | 636 | 66 | 82 | 1.89 | 42 | 4.3 | 1.12 |
| 29 | 2.0 | 0.48 | | | 600* | 950 | 21 | 12 | 723 | 60 | 82 | 2.19 | 45 | 4.5 | 1.19 |
| 30 | 1.2 | 0.28 | | | 500* | 900 | 17 | 11 | 634 | 65 | 83 | 2.08 | 44 | 4.3 | 1.13 |
| 31 | 2.0 | 0.48 | | | 500* | 950 | 22 | 13 | 719 | 60 | 84 | 2.41 | 50 | 4.9 | 1.28 |
| 32 | 1.2 | 0.28 | | | — | 900 | 15 | 12 | 633 | 65 | 82 | 2.17 | 43 | 4.3 | 1.07 |
| 33 | 1.2 | 0.48 | | | — | 950 | 23 | 15 | 645 | 64 | 83 | 2.98 | 49 | 4.9 | 1.44 |
| 34 | 2.0 | 0.28 | | | — | 950 | 21 | 14 | 722 | 60 | 81 | 2.44 | 47 | 5.0 | 1.34 |
| 35 | 2.0 | 0.48 | | | — | 1000 | 25 | 16 | 749 | 59 | 83 | 3.02 | 50 | 5.0 | 1.49 |

28 to 31: Examples of aging after the hot rolling (before the cold rolling)
32 to 35: Rate of temperature increase, 50° C./s in the solution treatment

Alloys of No. 1 to 22 are examples of the invention and are satisfactory in all of strength, conductivity, bending workability, and stress relaxation characteristic in a balanced manner. Variations in strength, bending workability, and stress relaxation characteristic are small.

Regarding alloys of No. 23 to 27 obtained without performing the first aging treatment, the grains were coarsened in the solution treatment, and thus variations in strength, bending workability, and stress relaxation characteristic deteriorated.

Regarding alloys of No. 28 to 31 obtained by performing the first aging treatment after the hot rolling and performing the solution treatment after the cold rolling, strains were not added before the first aging treatment, but added before the solution treatment, and thus the grain size increased. In addition, since the variation was also large, variations in strength, bending workability, and stress relaxation characteristic deteriorated.

Regarding alloys of No. 32 to 35 obtained by increasing the rate of temperature increase in the solution treatment to 50° C./s without performing the first aging treatment, variations were caused in size and amount of second phase particles when trying to control the grains. In addition, since strains were added before the solution treatment, the grains were coarsened, and strength and bending workability thus deteriorated. In addition, the variation in grain size became large. As a result, the variation in stress relation characteristic became large.

1. A copper alloy for an electronic material, the copper alloy comprising 0.5% by mass to 3.0% by mass of Co, 0.1% by mass to 1.0% by mass of Si, and the balance Cu with inevitable impurities,
wherein an average grain size is in the range of 3 μm to 15 μm and an average difference between a maximum grain size and a minimum grain size in every observation field of 0.05 mm² is 5 μm or less.

2. The copper alloy for the electronic material according to claim 1, the copper alloy further comprising Cr in an amount of up to 0.5% by mass.

3. The copper alloy for the electronic material according to claim 1, the copper alloy further comprising one or two or more selected from Mg, Mn, Ag, and P in total in an amount of up to 0.5% by mass.

4. The copper alloy for the electronic material according to claim 1, the copper alloy further comprising one or two selected from Sn and Zn in total in an amount of up to 2.0% by mass.

5. The copper alloy for the electronic material according to claim 1, the copper alloy further comprising one or two or more selected from Ni, As, Sb, Be, B, Ti, Zr, Al, and Fe in total in an amount of up to 2.0% by mass.

6. A method of manufacturing the copper alloy according to claim 1, the method comprising:
a step 1 in which an ingot having a desired composition is melted and cast;
a step 2 in which the ingot is heated for 1 hour or longer at 950° C. to 1050° C., hot-rolled, and then cooled at an average cooling rate of 15° C./s or greater from 850° C. or higher as a temperature at the end of the hot rolling to 400° C.;
a cold rolling step 3 at a processing ratio of 70% or greater;
an aging treatment step 4 in which the cold-rolled material is heated for 1 minute to 24 hours at 510° C. to 800° C.;
a step 5 in which the aged material is subjected to a solution treatment at 850° C. to 1050° C. and cooled at an average cooling rate of 15° C./s or greater when the material temperature is reduced from 850° C. to 400° C.;
an optional cold rolling step 6;
an aging treatment step 7; and
an optional cold rolling step 8,
wherein the steps are sequentially performed.

7. An wrought copper product comprising the copper alloy according to claim 1.

8. An electronic equipment component comprising the copper alloy according to claim 1.

9. The copper alloy for the electronic material according to claim 2, the copper alloy further comprising one or two or more selected from Mg, Mn, Ag, and P in total in an amount of up to 0.5% by mass.

10. The copper alloy for the electronic material according to claim 2, the copper alloy further comprising one or two selected from Sn and Zn in total in an amount of up to 2.0% by mass.

11. The copper alloy for the electronic material according to claim 2, the copper alloy further comprising one or two or more selected from Ni, As, Sb, Be, B, Ti, Zr, Al, and Fe in total in an amount of up to 2.0% by mass.

12. A method of manufacturing the copper alloy according to claim 2, the method comprising:
a step 1 in which an ingot having a desired composition is melted and cast;
a step 2 in which the ingot is heated for 1 hour or longer at 950° C. to 1050° C., hot-rolled, and then cooled at an average cooling rate of 15° C./s or greater from 850° C. or higher as a temperature at the end of the hot rolling to 400° C.;
a cold rolling step 3 at a processing ratio of 70% or greater;
an aging treatment step 4 in which the cold-rolled material is heated for 1 minute to 24 hours at 510° C. to 800° C.;
a step 5 in which the aged material is subjected to a solution treatment at 850° C. to 1050° C. and cooled at an average cooling rate of 15° C./s or greater when the material temperature is reduced from 850° C. to 400° C.;
an optional cold rolling step 6;
an aging treatment step 7; and
an optional cold rolling step 8,
wherein the steps are sequentially performed.

13. An wrought copper product comprising the copper alloy according to claim 2.

14. An electronic equipment component comprising the copper alloy according to claim 2.
